(19) United States
(12) Patent Application Publication
(10) Pub. No.: US 2007/0105727 A1
(43) Pub. Date: May 10, 2007

(54) Water-base lubricant for plastic forming

(75) Inventors: Yoshihisa Doi, Tochigi-ken (JP); Masayoshi Sakakibara, Kanagawa-ken (JP); Kenji Sakai, Kanagawa-ken (JP); Koichi Goto, Kanagawa-ken (JP); Hiroaki Yoshida, Aichi-ken (JP); Shigekazu Ito, Aichi-ken (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: HONDA MOTOR CO., LTD.

(21) Appl. No.: 10/580,829

(22) PCT Filed: Nov. 25, 2004
(86) PCT No.: PCT/JP04/17465

§ 371 Date: Jan. 3, 2007

(30) Foreign Application Priority Data
Nov. 26, 2003 (JP) 2003-395677

(51) Int. Cl. C01G 39/06; C10L 1/18

(52) U.S. Cl. 508/167; 508/466; 508/579

(57) ABSTRACT

The present invention provides an aqueous lubricant for plastic working which comprises (a) 10 to 40% by mass of a solid lubricating agent; (b) 2 to 20% by mass of an attaching agent having both lubricating and dispersing properties; (c) 2 to 20% by mass of an agent having both wetting characteristics and moisture evaporation-accelerating actions; and water. The use of this lubricant solves problems associated with conventional aqueous lubricants such that it has insufficient lubricating property and likewise permit the completion of a plurality of continuous plastic working steps, starting from a raw material and extending over a final product, without suspending a series of these plastic working steps in the middle thereof.

### TECHNICAL FIELD

The present invention relates to an aqueous lubricant for plastic working, which is used for plastic working of metallic materials such as carbon steel, special steel and non-ferrous metals and in particular to an aqueous lubricant for plastic working, which can be supplied to the surface of a high temperature material to be processed within a short period of time to form a lubricant coating thereon and to thus enable forging of the material.

### BACKGROUND ART

As cold forging technique, there has been known a method which comprises the step of forming, in advance, a lubricant coating for conversion treatments such as zinc phosphate (hereafter referred to as “phosphate coating”) on the surface of a metallic material to be forged for completion of cold forging treatment while making use of the initial lubricant coating without supplying any additional lubricant during processing (see, for instance, Patent Document 1 specified below). If the cold forging treatment is repeated over a plurality of times in this method, however, the initial lubricant coating is consumed and as a result, the material may undergo seizure during the processing due to, for instance, exhaustion of the lubricant coating.

To eliminate this problem, there has been adopted a method in which working treatment is carried out while lubricating a metal mold with a lubricating oil containing an oil-soluble extreme pressure additive or a method in which the working treatment is interrupted, the material to be processed is once removed from forging line, the material is re-heated, then a phosphate coating is again formed on the material and the material is returned to the forging line to thus complete the working treatment (see, for instance, Patent Document 2 specified later).

However, the oil-soluble lubricating oil may be accompanied by a risk of causing a fire and accordingly, there has also been investigated switching over the same to a water-soluble lubricant or a water-soluble lubricating coating (see, for instance, Patent Document 3, Patent Document 4, Patent Document 5, Patent Document 6, Patent Document 7, Patent Document 8 and Patent Document 9 specified later). However, the conventional water-soluble lubricants are not necessarily sufficient in their lubricating properties.

Accordingly, there has been desired for development of an aqueous lubricating agent for plastic working, which is used in plastic working treatments such as forging, in particular, in plastic working treatments comprising a plurality of steps and requiring the use of severe molding environments such as a high contact pressure and a high extension ratio, which is not accompanied with any danger of causing a fire, which can withstand severe molding environment requiring a high contact pressure and a high extension ratio, which can form a highly dense and tough coating immediately after the supply of the same to a metal mold, and which permits completion of a plurality of continuous plastic working steps till the final step without suspending a series of these plastic working steps in the middle thereof.
Patent Document 1:
   Japanese Laid-Open Patent Publication No. 62-100595;
Patent Document 2:
   Japanese Laid-Open Patent Publication No. 1-166841;
Patent Document 3:
   Japanese Laid-Open Patent Publication No. 5-279689;
Patent Document 4:
   Japanese Laid-Open Patent Publication No. 6-1994;
Patent Document 5:
   Japanese Laid-Open Patent Publication No. 10-8085;
Patent Document 6:
   Japanese Laid-Open Patent Publication No. 10-46184;
Patent Document 7:
   Japanese Laid-Open Patent Publication No. 11-50083;
Patent Document 8:
   Japanese Laid-Open Patent Publication No. 11-323363;
Patent Document 9:
   Japanese Laid-Open Patent Publication No. 2001-323294

### DISCLOSURE OF THE INVENTION

Problems to be Solved by the Invention

It is an object of the present invention to provide an aqueous lubricant for plastic working, which can eliminate the problem of insufficient lubricating property as a drawback of conventional aqueous lubricants and which permits completion of a plurality of continuous plastic working steps, starting from raw material and extending over a final product, without suspending a series of these plastic working steps in the middle thereof.

Means for Solving the Problems

The present invention herein provides a lubricating agent detailed below:
1. An aqueous lubricant for plastic working comprising (a) 10 to 40% by mass of a solid lubricating agent; (b) 2 to 20% by mass of an attaching agent having both lubricating and dispersing properties; (c) 2 to 20% by mass of an agent having both wetting characteristics and moisture evaporation-accelerating actions; and water.
2. The aqueous lubricant for plastic working as set forth in the foregoing item 1, wherein the solid lubricating agent (a) comprises molybdenum disulfide.
3. The aqueous lubricant for plastic working as set forth in the foregoing item 1 or 2, wherein the attaching agent (b) having both lubricating and dispersing properties comprises an isobutylene-maleic acid copolymer.
4. The aqueous lubricant for plastic working as set forth in any one of the foregoing items 1 to 3, wherein the agent (c) having both wetting characteristics and moisture evaporation-accelerating actions comprises alkylene glycols.
5. The aqueous lubricant for plastic working as set forth in any one of the foregoing items 1 to 4, wherein the plastic working is cold forging.

### EFFECTS OF THE INVENTION

The aqueous lubricant for plastic working according to the present invention is one obtained by dissolving and dispersing, in an aqueous solution, a solid lubricating agent, an attaching agent having both lubricating and dispersing properties and an agent having both wetting characteristics and moisture evaporation-accelerating actions and the aqueous lubricant for plastic working simultaneously possesses the following characteristic properties: (1) dispersion stability of the solid lubricating agent in water, (2) uniform adhesion, (3) quick-drying property, (4) adhesion strength of coating to a material to be processed and (5) high lubricating property. Accordingly, there is not any risk of causing a fire. Moreover, for instance, if the lubricant is supplied to a metal mold, in the cold forging of a metallic material which includes a plurality of plastic working steps requiring a high working ratio, it is not necessary to remove the material to be processed and to subject the same to an annealing treatment and accordingly, a series of the cold forging operations can be proceeded without any interruption till a processed article having a final shape can be obtained.

### BEST MODE FOR CARRYING OUT THE INVENTION

In cold forging which includes a plurality of plastic working steps requiring a high working ratio, a coating of a lubricant is preliminarily formed on the surface of a material to be processed prior to the forging and the whole working steps starting from a raw material and extending over a final step are carried out without supplementing any lubricant to a metal mold, or each plastic working step is carried out while supplementing a lubricant to a metal mold. However, the former method suffers from a problem in that the initial lubricant coating is consumed and as a result, the material may undergo seizure during the processing due to, for instance, exhaustion of the lubricant coating, while the latter method likewise suffers from a problem such that the working efficiency is considerably lowered.

The present invention herein provides an aqueous lubricant for plastic working which permits the instantaneous formation (within two seconds) of a highly dense and tough coating of a lubricant onto the surface of a material to be processed when supplementing the lubricant thereto immediately before each step during the forging and which accordingly, permits the continuous completion of the forging comprising a plurality of plastic working steps even to a final step without suspending the forging in the middle thereof. The lubricant used for such purposes should satisfy the following requirements, simultaneously: (1) dispersion stability of a solid lubricating agent in water, (2) uniform adhesion, (3) quick-drying property, (4) adhesion strength of coating to a material to be processed and (5) high lubricating property (comparable to those observed for a phosphate coating in a severe molding environment requiring a high contact pressure and a high extension ratio).

The present invention relates to an aqueous lubricant for plastic working which is characterized in that it comprises (a) a solid lubricating agent; (b) an attaching agent having both lubricating and dispersing properties; (c) an agent having both wetting characteristics and moisture evaporation-accelerating actions, which are dissolved and dispersed in water; and which can satisfy all of the foregoing requirements (1) to (5).

The solid lubricating agent as the component (a) used in the present invention is desirably one having an effect of reducing a coefficient of friction at a temperature of not more than 500° C. and examples thereof include fluorinated graphite, graphite, adducts (MCA) of melamine with cyanuric acid, molybdenum disulfide, tungsten disulfide, surface-treated fine particulate calcium carbonate, and surface-treated fine particulate aluminum hydroxide. Among them, more preferably used herein is molybdenum disulfide. These solid lubricating agents may be used alone or in any combination of two or more of them.

Examples of the attaching agents each having both lubricating and dispersing properties as the component (b) used in the present invention include polyvinyl pyrrolidone and isobutylene-maleic acid copolymers. Preferably used herein are isobutylene-maleic acid copolymers. Specific examples of such copolymers are sodium salts of isobutylene-maleic acid copolymers, potassium salts of isobutylene-maleic acid copolymers, lithium salts of isobutylene-maleic acid copolymers, ammonium salts of isobutylene-maleic acid copolymers, salts of isobutylene-maleic acid copolymers with primary amines having not more than 5 carbon atoms, salts of isobutylene-maleic acid copolymers with alkanol amines having not more than 3 carbon atoms, ammonium salts of half methyl esters of isobutylene-maleic acid copolymers, and ammonium salts of half ethyl esters of isobutylene-maleic acid copolymers. Among them, particularly preferred are ammonium salts of isobutylene-maleic acid copolymer obtained by neutralizing isobutylene : maleic anhydride (molar ratio=1:1) copolymer having a molecular weight ranging from 50,000 to 400,000 with ammonia to a degree of neutralization ranging from 0.6 to 1.0. These isobutylene-maleic acid copolymers may be used alone or in any combination of two or more of them.

As the agent having both wetting characteristics and moisture evaporation-accelerating actions as the component (c) used in the present invention, there may be listed, for instance, alkylene glycols and in particular, preferably used herein are alkylene glycols having a boiling point of not less than 150° C. Specific examples of such alkylene glycols include ethylene glycol (boiling point: 198° C.), diethylene glycol (boiling point: 246° C.), triethylene glycol (boiling point: 285° C.), ethylene glycol mono-t-butyl ether (boiling point: 153° C.) and ethylene glycol monobutyl ether (boiling point: 171° C.). Among them, diethylene glycol is particularly preferred. These agents may be used alone or in any combination of two or more of them.

In the lubricant of the present invention, the amount of each component to be incorporated into the lubricant ranges from 10 to 40% by mass and preferably 15 to 30% by mass for the component (a); 2 to 20% by mass and preferably 4 to 12% by mass for the component (b); and 2 to 20% by mass and preferably 3 to 12% by mass for the component (c) if the total amount of the lubricant (stock solution) is assumed to be 100% by mass.

If the amount of the component (a) to be incorporated into the lubricant is less than 10% by mass, the coating of the lubricant formed when adhered to a material to be processed is too thin and this results in insufficient lubricating property, while if it exceeds 40% by mass, the resulting lubricant product has an elevated viscosity and the workability thereof upon handling is considerably deteriorated.

If the amount of the component (b) to be incorporated into the lubricant is less than 2% by mass, the resulting lubricant does not have the required dispersion stability of the solid lubricating agent and the required adhesion thereof to a material to be processed, while if it exceeds 20% by mass, the resulting lubricant product has an elevated viscosity and the adhesion thereof is also reduced.

If the amount of the component (c) to be incorporated into the lubricant is less than 2% by mass, the resulting lubricant does not have the required moisture evaporation-accelerating effect and it may provide a coating having an insufficient drying property, while the use thereof in an amount of more than 20% by mass may impair the dispersion stability, in water, of the solid lubricating agent as the component (a).

Accordingly, it is essential to the aqueous lubricant for plastic working according to the present invention that it comprises 10 to 40% by mass of a solid lubricating agent as the component (a); 2 to 20% by mass of an attaching agent having both lubricating and dispersing properties as the component (b); 2 to 20% by mass of an agent having both wetting characteristics and moisture evaporation-accelerating actions as the component (c); and water, in order to satisfy the following requirements, simultaneously: (1) dispersion stability of a solid lubricating agent in water, (2) uniform adhesion, (3) quick-drying property, (4) adhesion strength of coating to a material to be processed and (5) high lubricating property.

The lubricant of the present invention can easily be prepared by dissolving, in advance, the component (b) and the component (c) in water and then uniformly dispersing the component (a) in the resulting solution using, for instance, a stirring machine. To reduce the time required for the dispersion thereof, it is also possible to use a means such as a homogenizer, a homomixer and/or Manton-Gaulin dispersing machine.

Moreover, the lubricant of the present invention desirably comprises additives currently used in conventional lubricants such as an anti-foaming agent, an antiseptic agent and/or an anti-corrosive agent, in amounts conventionally employed.

The lubricant of the present invention thus obtained is diluted 2 to 10 times with water prior to practical use and it is in general used in the form of an aqueous dispersion and is applied onto an object through spraying. It is suitable that the aqueous lubricant for plastic working according to the present invention is preferably intermittently sprayed on the surface of a material to be processed within a short period of time and then dried, but the present invention is not restricted to such a particular embodiment. More specifically, the spray of the aqueous lubricant is preferably carried out as intermittent spraying actions (each spraying time ranges from 0.1 to 0.5 second) at intervals of 0.01 to 0.05 second over a period of 1 to 2 seconds to thus form a coating of the lubricant on the surface of the material to be processed.

The lubricant of the present invention can be applied to plastic working of a variety of metallic materials and preferably it can be applied to cold forging of, in particular, metallic members such as those made of carbon steel and special steel, for instance, tripod joints.

### EXAMPLES

The present invention will hereafter be described in more specifically with reference to the following Examples and Comparative Examples.

### Examples 1 to 11 and Comparative Examples 1 to 6

Sample lubricants according to Examples 1 to 11 and Comparative Examples 1 to 5 were prepared using components specified in the following Tables 1 to 3. Each of these samples was diluted 10 times with water and then evaluated for various properties according to the test methods detailed below. In this connection, Comparative Example 6 was a zinc phosphate coating and therefore, it was inspected for only the adhesion of the coating to an object to be processed and the lubricating property.

[Dispersion Stability]

Each sample (100 cc each) was taken into a 100 cc volume messcylinder with ground-in stopper, the sample was then allowed to stand at room temperature over 48 hours, it was then examined for conditions of each sample to evaluate the same according to the following four-stage criteria. In this respect, the samples evaluated as ◯ or □ are judged to be practically acceptable.
◯: The sample is entirely uniform and completely free of floating matter and sediment;
□: The sample is uniform and free of floating matter. There are observed sediments, but the sample can be made uniform when shaking the cylinder over less than 10 times;
Δ: The upper layer of less than 5 cc is transparent. The sediments are not uniformly dispersed even when shaking the cylinder over not less than 10 times;
×: The upper layer of not less than 5 cc is transparent. The sediments are not uniformly dispersed even when shaking the cylinder over not less than 30 times.
   [Adhesiveness]

Each sample (2 cc each) was taken into a cup using a two-part hand gun (W-88-10K5G) available from ANEST IWATA Corporation. Each sample was then intermittently sprayed, 15 times, on the surface of a carbon steel piece (S10C: 46 mmφ×30 mm) heated to a predetermined temperature at an air pressure of 1.5 kg/cm² over 5 seconds, from a position 40 cm apart from the surface (spraying time: 0.3 second; spraying intervals: 0.03 second). The surface of the carbon steel piece was observed after the spray of each sample and evaluated on the basis of the following four-stage criteria. In this respect, the practically acceptable sample should be evaluated to be ◯.
◯: The sample is uniformly adhered to the entire surface of the carbon steel piece;
□: The sample is adhered to the entire surface of the piece, but the thickness thereof is irregular;
Δ: The sample is unevenly adhered to the surface (not less than 50% of the surface is covered with the adhered coating);
×: The sample is unevenly adhered to the surface (less than 50% of the surface is covered with the adhered coating).
   [Drying Property]

In the test for inspecting adhesiveness, a time required for complete drying of the sample immediately after the spraying was determined and evaluated according to the following three-stage evaluation criteria. In this respect, the practically acceptable sample should be evaluated to be ◯.
◯: The sample is immediately dried;
Δ: It takes 1 to 2 seconds for complete drying of the sample;
×: It takes not less than 2 seconds for complete drying of the sample.
   [Adhesion strength of coating to Steel Piece]

Each carbon steel piece after the test of drying property was allowed to cool down to room temperature, a Scotch tape was adhered to the piece with finger pressure and then the tape was peeled off. The degree of dirtiness of the tape was evaluated on the basis of the following three-stage criteria. In this respect, the practically acceptable sample should be evaluated to be ◯.
◯: The tape is not stained at all (the acceptable color of the tape is up to pale gray color);
Δ: The coating remains on the carbon steel piece, but the tape is stained in black color;
×: The coating is peeled off from the surface of the carbon steel piece.
   [Lubricating Property]

The lubricating property of each sample was evaluated according to the so-called “Spike Test” as disclosed in Japanese Laid-Open Patent Publication No. 5-7969. The conditions for the test are as follows:
1) Metal Mold: SKD-11 (150° C.);
2) Specimen: S10C (150° C.) 20 mmφ×30 mm in height;
3) Sample: Each sample diluted 10 times with water (0.05 cc) is sprayed on the specimen maintained at 150° C. at a time and the test is initiated within 5 seconds after sprayed.

4) Evaluation: Height (mm) of spike and load (t) of forging 5 were recorded. The lubricating property was expressed in terms of the ratio: (height of spike)/(load of forging) (mm/t). The value thereof required for practical use is not less than 0.135.

TABLE 1

| Ex. No. | | | | | |
|---|---|---|---|---|---|
| 1 | 2 | 3 | 4 | 5 | 6 |

(a) Solid Lubricating Agent

| | | | | | | |
|---|---|---|---|---|---|---|
| Molybdenum disulfide | 28 | 23 | 28 | 28 | 28 | 28 |
| Flake-like graphite | — | 5 | — | — | — | — |

(b) Attaching Agent Having Both Lubricating and Dispersing
Properties

| | | | | | | |
|---|---|---|---|---|---|---|
| Na Salt of Isobutylene- | 7 | 7 | — | — | — | — |
| maleic acid copolymer*¹ | | | | | | |
| NH₄ Salt of | — | — | 7 | — | — | 3.5 |
| Isobutylene-maleic acid | | | | | | |
| copolymer*² | | | | | | |
| Half ethyl ester, NH₄ | — | — | — | 7 | — | 3.5 |
| Salt of Iso-butylene-maleic acid | | | | | | |
| copolymer*³ | | | | | | |
| Polyvinyl pyrrolidone | — | — | — | — | 7 | — |

(c) Agent Having Both Wetting Characteristics and Moisture
Evaporation-Accelerating Actions

| | | | | | | |
|---|---|---|---|---|---|---|
| Ethylene glycol | 7 | 7 | 7 | 7 | 7 | 7 |
| Diethylene glycol | — | — | — | — | — | — |
| Ethyl alcohol | — | — | — | — | — | — |
| Isopropyl alcohol | — | — | — | — | — | — |
| (d) Other Additives | 1 | 1 | 1 | 1 | 1 | 1 |
| (Silicone type | | | | | | |
| antifoaming agent) | | | | | | |
| Water | 57 | 57 | 57 | 57 | 57 | 57 |
| Dispersion Stability | □ | □ | ∘ | ∘ | ∘ | ∘ |
| Adhesiveness: 150° C. | ∘ | ∘ | ∘ | ∘ | ∘ | ∘ |
| Adhesiveness: 200° C. | ∘ | ∘ | ∘ | ∘ | ∘ | ∘ |
| Drying property: 150° C. | ∘ | ∘ | ∘ | ∘ | ∘ | ∘ |
| Drying property: 200° C. | ∘ | ∘ | ∘ | ∘ | ∘ | ∘ |
| Adhesion strength of | ∘ | ∘ | ∘ | ∘ | ∘ | ∘ |
| coating: 150° C. | | | | | | |
| Lubricating Property: | 0.138 | 0.135 | 0.140 | 0.136 | 0.136 | 0.138 |
| Spike Test (mm/t) | | | | | | |

TABLE 2

| Ex. No. | | | | |
|---|---|---|---|---|
| 7 | 8 | 9 | 10 | 11 |

(a) Solid Lubricating Agent

| | | | | | |
|---|---|---|---|---|---|
| Molybdenum disulfide | 28 | 28 | 28 | 28 | 28 |
| Flake-like graphite | — | — | — | — | — |

(b) Attaching Agent Having Both Lubricating and Dispersing
Properties

| | | | | | |
|---|---|---|---|---|---|
| Na Salt of Isobutylene- | — | — | — | — | — |
| maleic acid copolymer*¹ | | | | | |
| NH₄ Salt of | 7 | 7 | — | 7 | 4 |
| Isobutylene-maleic acid | | | | | |
| copolymer*² | | | | | |
| Half ethyl ester, NH₄ | — | — | 7 | — | — |
| Salt of Iso-butylene- | | | | | |
| maleic acid copolymer*³ | | | | | |
| Polyvinyl pyrrolidone | — | — | — | — | — |

(c) Agent Having Both Wetting Characteristics and Moisture
Evaporation-Accelerating Actions

| | | | | | |
|---|---|---|---|---|---|
| Ethylene glycol | — | — | — | 5 | — |
| Diethylene glycol | 7 | 5 | 5 | — | 5 |
| Ethyl alcohol | — | 2 | 2 | — | 2 |
| Isopropyl alcohol | — | — | — | 2 | — |
| (d) Other Additives | 1 | 1 | 1 | 1 | 1 |
| (Silicone type | | | | | |
| antifoaming agent) | | | | | |
| Water | 57 | 57 | 57 | 57 | 60 |
| Dispersion Stability | ∘ | ∘ | ∘ | ∘ | □ |
| Adhesiveness: 150° C. | ∘ | ∘ | ∘ | ∘ | ∘ |
| Adhesiveness: 200° C. | ∘ | ∘ | ∘ | ∘ | ∘ |
| Drying property: 150° C. | ∘ | ∘ | ∘ | ∘ | ∘ |
| Drying property: 200° C. | ∘ | ∘ | ∘ | ∘ | ∘ |
| Adhesion strength of | ∘ | ∘ | ∘ | ∘ | ∘ |
| coating: 150° C. | | | | | |
| Lubricating Property: | 0.139 | 0.140 | 0.138 | 0.138 | 0.136 |
| Spike Test (mm/t) | | | | | |

TABLE 3

| Comp. Ex. No. | | | | | |
|---|---|---|---|---|---|
| 1 | 2 | 3 | 4 | 5 | 6*⁴ |

(a) Solid Lubricating Agent

| | | | | | |
|---|---|---|---|---|---|
| Molybdenum disulfide | 28 | 28 | — | 28 | 28 |

(b) Attaching Agent Having Both Lubricating and
Dispersing Properties

| | | | | | |
|---|---|---|---|---|---|
| NH₄ Salt of | 7 | — | 35 | 7 | 7 |
| Isobutylene-maleic acid copolymer*² | | | | | |

(c) Agent Having Both Wetting Characteristics and
Moisture Evaporation-Accelerating Actions

| | | | | | | |
|---|---|---|---|---|---|---|
| Ethylene glycol | — | 7 | 7 | — | 1 | |
| Ethyl alcohol | — | — | — | 7 | — | |
| (d) Other Additives | 1 | 1 | 1 | 1 | 1 | |
| (Silicone type antifoaming agent) | | | | | | |
| Water | 64 | 64 | 57 | 57 | 63 | |
| Dispersion Stability | Δ | x | ∘ | Δ | x | — |
| Adhesiveness: 150° C. | ∘ | x | ∘ | ∘ | ∘ | — |
| Adhesiveness: 200° C. | ∘ | x | ∘ | ∘ | ∘ | — |
| Drying property: 150° C. | x | ∘ | x | Δ | x | — |
| Drying property: 200° C. | ∘ | ∘ | x | ∘ | ∘ | — |
| Adhesion strength of coating: 150° C. | ∘ | x | ∘ | ∘ | ∘ | ∘ |
| Lubricating Property: Spike Test | 0.138 | 0.125 | 0.117 | 0.138 | 0.134 | 0.140 |
| (mm/t) | | | | | | |

*¹Na salt of isobutylene-maleic acid (1:1) copolymer (degree of neutralization: 0.8; Molecular weight: 200,000);
*²NH₄ Salt of Isobutylene-maleic acid (1:1) copolymer (degree of neutralization: 0.8; Molecular weight: 80,000);
*³Half ethyl ester, NH₄ Salt (1:1) of Isobutylene-maleic acid (1:1) copolymer (degree of neutralization: 0.8; Molecular weight: 88,000);
*⁴Zinc phosphate coating.

The foregoing data clearly indicate that the lubricants of Examples 1 to 11 of the present invention which comprise (a) 10 to 40% by mass of a solid lubricating agent; (b) 2 to 20% by mass of an attaching agent having both lubricating and dispersing properties; (c) 2 to 20% by mass of an agent having both wetting characteristics and moisture evaporation-accelerating actions; and water, are all excellent in (1) dispersion stability, (2) uniform adhesion, (3) quick-drying property, (4) adhesion strength of coating to a material to be processed and (5) lubricating property.

Contrary to this, the lubricants prepared in Comparative Examples 1 to 5 suffer from the following problems:

More specifically, the lubricant prepared in Comparative Example 1 which does not comprise an agent having both wetting characteristics and moisture evaporation-accelerating actions serving as the component (c) is insufficient in dispersion stability and drying property at 150° C.

The lubricant prepared in Comparative Example 2 which does not comprise an attaching agent having both lubricating and dispersing properties serving as the component (b) is inferior in drying property, uniform adhesion, adhesion strength of coating to a material to be processed and lubricating property.

The lubricant prepared in Comparative Example 3 which does not comprise a solid lubricating agent serving as the component (a) is inferior in drying property and lubricating property.

The lubricant prepared in Comparative Example 4 which does not comprise an agent having both wetting characteristics and moisture evaporation-accelerating actions serving as the component (c) is inferior in dispersion stability and drying property at 150° C.

The lubricant prepared in Comparative Example 5 which makes use of ethylene glycol in an amount of 1% by mass as an agent having both wetting characteristics and moisture evaporation-accelerating actions or the component (c) is insufficient in dispersion stability, drying property at 150° C. and lubricating property.

### INDUSTRIAL APPLICABILITY

The aqueous lubricant for plastic working of the present invention prepared by dissolving and dispersing a solid lubricating agent, an attaching agent having both lubricating and dispersing properties and an agent having both wetting characteristics and moisture evaporation-accelerating actions in an aqueous solution can simultaneously satisfy the following requirements: (1) dispersion stability of the solid lubricating agent in water, (2) uniform adhesion, (3) quick-drying property, (4) adhesion strength of coating to a material to be processed and (5) high lubricating property. For this reason, there is not any risk of causing a fire. Moreover, for instance, if the lubricant is supplied to a metal mold, in cold forging of a metallic material which includes a plurality of plastic working steps requiring a high working ratio, it is not necessary to remove the material to be processed and to subject the same to an annealing treatment and accordingly, a series of cold forging operations can be proceeded without any interruption till a processed article having a final shape can be obtained.

1. An aqueous lubricant for plastic working comprising (a) 10 to 40% by mass of a solid lubricating agent; (b) 2 to 20% by mass of an attaching agent having both lubricating and dispersing properties; (c) 2 to 20% by mass of an agent having both wetting characteristics and moisture evaporation-accelerating actions; and water.

2. The aqueous lubricant for plastic working as set forth in claim 1, wherein the solid lubricating agent (a) comprises molybdenum disulfide.

3. The aqueous lubricant for plastic working as set forth in claim 1, wherein the attaching agent (b) having both lubricating and dispersing properties comprises an isobutylene-maleic acid copolymer.

4. The aqueous lubricant for plastic working as set forth in claim 1, wherein the agent (c) having both wetting characteristics and moisture evaporation-accelerating actions comprises alkylene glycols.

5. The aqueous lubricant for plastic working as set forth in claim 1, wherein the solid lubricating agent (a) comprises molybdenum disulfide; the attaching agent (b) having both lubricating and dispersing properties comprises an isobutylene-maleic acid copolymer; and the agent (c) having both wetting characteristics and moisture evaporation-accelerating actions comprises alkylene glycols.

6. The aqueous lubricant for plastic working as set forth in claim 1, wherein the plastic working is cold forging.
